(19) United States
(12) Patent Application Publication
(10) Pub. No.: US 2008/0073465 A1
(43) Pub. Date: Mar. 27, 2008

(54) Multi-Layer Interior Fitting Component

(75) Inventors: Bernd Veihelmann, Ulm (DE); Helmut Junginger, Burgrieden/Rot (DE)

Correspondence Address: WOOD, HERRON & EVANS, LLP, 2700 CAREW TOWER, 441 VINE STREET, CINCINNATI, OH, 45202, US

(73) Assignee: Airbus Deutschland GmbH, Hamburg (DE)

(21) Appl. No.: 11/850,757

(22) Filed: Sep. 6, 2007

Related U.S. Application Data
(60) Provisional application No. 60/824,621, filed on Sep. 6, 2006.

(30) Foreign Application Priority Data
Sep. 6, 2006 (DE) DE 102006041787.9

(51) Int. Cl. B64C 7/00

(52) U.S. Cl. 244/133

(57) ABSTRACT

A multi-layer interior fitting component (10) comprises a transparent surface layer (12) consisting of a thermoplastic plastics material as well as a carrier layer (14) consisting of a foam. In a method for producing an interior fitting component (10) a transparent surface layer (12) consisting of a thermoplastic plastics material is provided and joined to a carrier layer (14) consisting of a foam.

The invention relates to a multi-layer interior fitting component which is in particular suitable for use in an aircraft cabin, with a transparent surface layer consisting of a thermoplastic plastics material, as well as a method for producing an interior fitting component of this kind.

Panel-shaped elements which are currently used as interior fitting components in an aircraft cabin comprise a basic structure which is shaped as a side covering, door frame covering, ceiling covering or similar, according to the purpose of the interior fitting components, which structure is usually in the form of a sandwich/honeycomb structure and consists, for example, of a glass fibre material. A multi-layer decorative laminate is glued onto the basic structure.

The decorative laminate comprises a first layer consisting of a thermoplastic plastics film as well as an embossing layer which is applied to the first layer. An embossing layer is understood to be a layer which is dyed a desired colour, for example, and can receive an embossed surface structure on its surface which is facing away from the first layer. Finally, a surface layer which likewise consists of a thermoplastic plastics film is applied to the embossing layer. The decorative laminate can be joined to the basic structure by means of an adhesive film, for example, which is applied to a surface of the first thermoplastic film layer which is facing away from the embossing layer.

The panel elements which are currently used as interior fitting components in an aircraft cabin entail the problem of the decorative laminate only being of limited suitability for compensating for or concealing surface defects of the basic structure, in particular on account of the low elasticity or flexibility of the embossing layer. A time-consuming and labour-intensive and therefore expensive surface treatment of the basic structure is for this reason necessary before applying the decorative laminate. Moreover, it has become apparent that the surface of the panel elements which is formed by the decorative laminate is hard and brittle to the touch, so that contact may be experienced as cold and therefore unpleasant.

The object of the invention is to provide a multi-layer interior fitting component which is in particular suitable for use in an aircraft cabin, renders an expensive surface treatment of a basic structure or the use of a basic structure as a whole dispensable and the surface of which is pleasant to the touch.

In order to achieve this object, a multi-layer interior fitting component according to the invention which is in particular suitable for use in an aircraft cabin comprises a carrier layer consisting of a foam in addition to a transparent surface layer consisting of a thermoplastic plastics material.

The transparent surface layer of the interior fitting component according to the invention may consist, for example, of a transparent polyvinylidene fluoride film or polyvinyl fluoride film. A pattern applied by means of screen printing or digital printing can be printed onto the surface of the surface layer which faces the foam carrier layer. Furthermore, the surface layer has good cleaning properties as well as a high scratch resistance and is therefore particularly suitable as a protective layer for the carrier layer consisting of a foam.

The thickness of the carrier layer consisting of a foam can be adapted in accordance with the intended application of the interior fitting component according to the invention. It is therefore possible, in the case of an interior fitting component which is not subjected to an excessive mechanical load, to form the component as a self-supporting component and to dispense with the use of a basic structure, as is absolutely necessary in the case of the interior fitting components which are known from the prior art. Instead the carrier layer, which consists of a foam and is therefore very easy to shape, can be easily brought into the desired shape and joined to the transparent surface layer at the same time. Considerable savings in terms of costs and weight are as a result possible.

A further advantage of the interior fitting component according to the invention lies in the fact that the carrier layer consisting of a foam is distinctly softer than the embossing layer contained in the interior fitting components which are known from the prior art. The surface of the interior fitting component according to the invention is therefore softer to the touch (soft touch effect).

If the interior fitting component according to the invention is subjected to higher mechanical load, the interior fitting component is preferably provided with a stiffening structure which is joined to the carrier layer consisting of a foam. The stiffening structure enables the mechanical properties of the interior fitting component to be adapted to increased mechanical requirements, although still makes it possible to dispense with the basic structure which is absolutely necessary in the case of the interior fitting components which are known from the prior art.

However, as an alternative to this, it is also possible to provide the interior fitting component according to the invention with an additional basic structure, in which case the carrier layer, consisting of a foam, of the interior fitting component can then be applied to the basic structure by means of an adhesive film, for example. An interior fitting component according to the invention which comprises an additional basic structure has particularly good mechanical properties and can therefore be used to advantage in particular when the interior fitting component is subjected to particularly high mechanical load. In contrast to a brittle embossing layer which is used in the decorative laminate of a conventional interior fitting component, the carrier layer consisting of a foam enables surface defects of the basic structure to be compensated for and concealed on account of its flexibility. It is for this reason possible to dispense with an expensive surface treatment of the basic structure. Considerable savings in terms of costs are as a result possible.

The carrier layer, consisting of a foam, of the interior fitting component according to the invention is preferably dyed a desired colour. The carrier layer consisting of a foam can then perform the additional function of giving the interior fitting component according to the invention the desired aesthetic properties.

In a preferred embodiment of the interior fitting component according to the invention the carrier layer consisting of a foam also comprises a surface structure, which is preferably produced by embossing, on its surface which faces the transparent surface layer.

The foam carrier layer consists, for example, of a thermoplastic foam such as, e.g. polyvinylidene fluoride foam, polyvinyl fluoride foam, polyamide foam, polysulphone foam or polyphenyl sulphone foam. However, as an alternative to this, the carrier layer consisting of a foam may also be formed by a silicone foam layer.

The carrier layer consisting of a foam preferably has a density between 15 kg/m³ and 120 kg/m³. Generally speaking, the density of the foam carrier layer can be adapted to the desired application of the interior fitting component according to the invention. In the case of a component which is subjected to little mechanical load, a foam carrier layer of a low density is preferably selected in order to make the interior fitting component as lightweight as possible. On the other hand, in the case of a component which is subjected to higher mechanical load, it may be desirable to provide the interior fitting component with a foam carrier layer of a higher density in order to improve its mechanical properties.

The interior fitting component according to the invention may also comprise an intermediate layer which consists of a dyed thermoplastic plastics material and is disposed between the carrier layer consisting of a foam and the transparent surface layer consisting of a thermoplastic plastics material. Generally speaking, if an intermediate layer which consists of a dyed thermoplastic plastics material is used, it is not necessary to dye the foam forming the carrier layer. However, should this be desirable, for example in order to obtain special colour effects or similar, both a carrier layer consisting of a dyed foam and an intermediate layer consisting of a dyed thermoplastic plastics material can be used. A dyed polyvinylidene fluoride film or polyvinyl fluoride film can be used as the dyed thermoplastic intermediate layer, for example.

Additionally or alternatively to an intermediate layer consisting of a dyed thermoplastic plastics material, the interior fitting component according to the invention may also comprise an intermediate layer which consists of a dyed lacquer and is disposed between the carrier layer consisting of a foam and the transparent surface layer consisting of a thermoplastic plastics material. A dyed resin layer can be used as the lacquer intermediate layer, for example. The resin can then, for example, be applied to a thermoplastic plastics film forming the transparent surface layer and then joined to the carrier layer consisting of a foam at the same time as the film.

In a method according to the invention for producing a multi-layer interior fitting component a transparent surface layer consisting of a thermoplastic plastics material is provided and joined to a carrier layer consisting of a foam.

The carrier layer consisting of a foam can be dyed. It is also possible to provide the carrier layer consisting of a foam with a surface structure, preferably by embossing. The carrier layer consisting of a foam is then preferably joined to the transparent surface layer consisting of a thermoplastic plastics material so that the surface of the carrier layer provided with the surface embossing faces the surface layer.

An intermediate layer consisting of a dyed thermoplastic plastics material can be disposed between the carrier layer consisting of a foam and the transparent surface layer consisting of a thermoplastic plastics material.

Alternatively or additionally to this, an intermediate layer consisting of a dyed lacquer can also be disposed between the carrier layer consisting of a foam and the transparent surface layer consisting of a thermoplastic plastics material, in which case the lacquer intermediate layer can, for example, be applied to a thermoplastic plastics film forming the transparent surface layer and then joined to the carrier layer consisting of a foam at the same time as the film.

The carrier layer consisting of a foam and the transparent surface layer consisting of a thermoplastic plastics material can be joined together by hot-joining, welding or gluing. Should the interior fitting component according to the invention comprise an intermediate layer consisting of a dyed thermoplastic plastics material and/or an intermediate layer consisting of a dyed lacquer, these intermediate layers can likewise be joined to the respective layers adjacent to them by hot-joining, welding or gluing. If a gluing method is used to join two layers of the interior fitting component according to the invention, an adhesive film is preferably applied to a surface of a layer to be joined to an adjacent layer before this layer is joined to the adjacent layer.

In a particularly preferred method for producing an interior fitting component the carrier layer consisting of a foam and the transparent surface layer consisting of a thermoplastic plastics material are roll-treated by at least one profiling roll and joined together during rolling. The carrier layer and the surface layer are preferably passed through between two rolls disposed opposite one another and joined together during this rolling step by means of an adhesive layer, for example. The adhesive layer may be heated before rolling takes place.

If the interior fitting component which is to be produced is also to comprise an intermediate layer consisting of a dyed thermoplastic plastics material and/or an intermediate layer consisting of a dyed lacquer, it is of course also possible to join these layers to the foam carrier layer and/or the transparent surface layer by rolling with at least one profiling roll, optionally using appropriate adhesive layers.

The carrier layer consisting of a foam can easily be provided with the desired surface structure by rolling with at least one profiling roll. Regions of compressed foam are then obtained in the surface region of the carrier layer. Welding of the foam forming the carrier layer to the layer(s) applied to the carrier layer takes place during rolling, in particular in these compressed regions, so that a particularly good bond is produced here. In other words, the foam carrier layer can be provided with the desired surface structure in a single method step and joined to the layer(s) disposed on the carrier layer at the same time.

Depending on the intended application of the interior fitting component and, in particular, depending on the mechanical requirements to be met by the interior fitting component, the carrier layer consisting of a foam can be joined to a stiffening structure and/or a basic structure. For this purpose an adhesive layer, for example, can be applied to a surface of the carrier layer which is to be joined to the stiffening structure and/or the basic structure.

Preferred embodiments of the invention are illustrated in detail in the following on the basis of the accompanying schematic drawings, of which

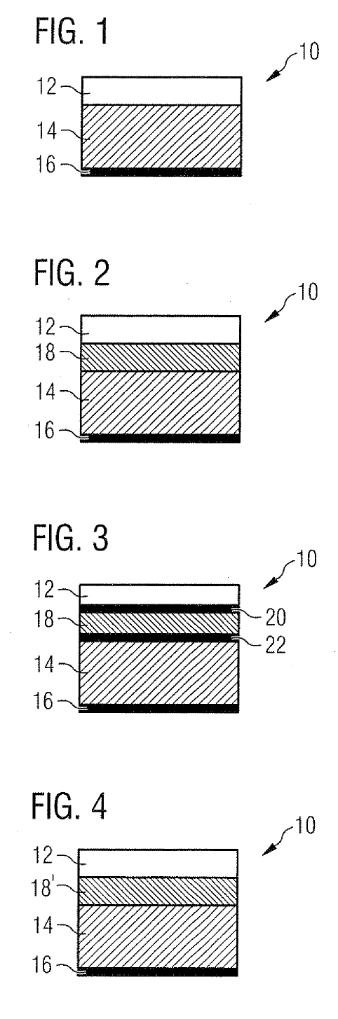

FIG. 1 is a representation of the layer structure of an interior fitting component according to a first embodiment of the invention,

FIG. 2 is a representation of the layer structure of an interior fitting component according to a second embodiment of the invention,

FIG. 3 is a representation of the layer structure of an interior fitting component according to a third embodiment of the invention,

FIG. 4 is a representation of the layer structure of an interior fitting component according to a fourth embodiment of the invention,

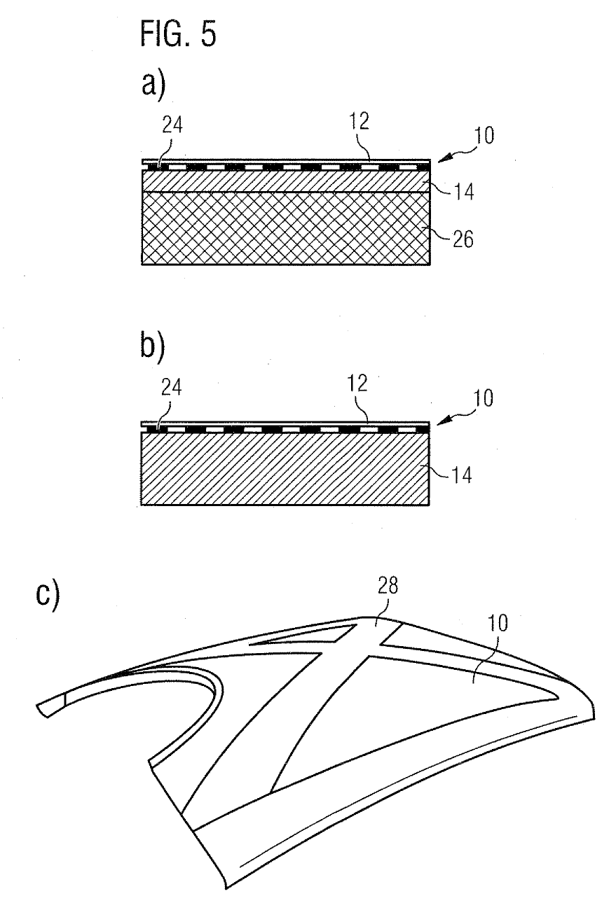

FIGS. 5A to C show examples of applications of the interior fitting component according to the invention as a decorative layer, as a self-supporting decorative shell and as a stiffened self-supporting decorative shell,

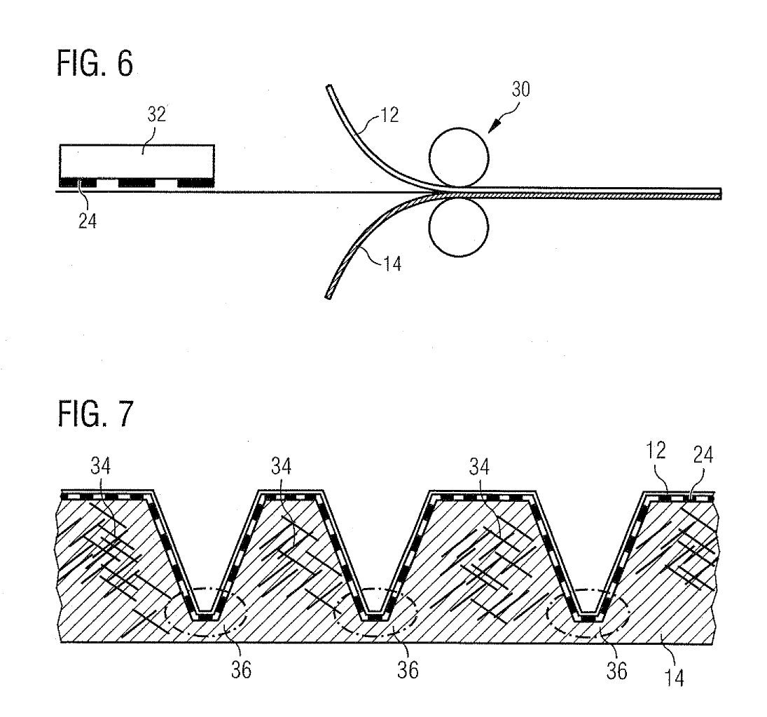

FIG. 6 shows an embodiment of a method according to the invention for producing a multi-layer interior fitting component and

FIG. 7 is an enlarged representation of the surface structure of an interior fitting component produced according to the method which is represented in FIG. 6.

FIG. 1 shows the layer structure of a first embodiment of an interior fitting component 10. The interior fitting component 10 comprises a surface layer 12 which is formed by a transparent film consisting of polyvinylidene fluoride or polyvinyl fluoride. The surface layer 12 is applied to a carrier layer 14 and printed with a desired pattern on its surface which faces the carrier layer 14. Screen printing methods or digital printing methods can be used to print the polyvinylidene fluoride film or polyvinyl fluoride film.

The carrier layer 14 consists of polyvinylidene fluoride foam or polyvinyl fluoride foam. Depending on the desired application of the interior fitting component 10 and, in particular, depending on the mechanical requirements to be met by this component, a polyvinylidene fluoride foam or a polyvinyl fluoride foam of a density between 15 kg/m³ and 120 kg/m³ can be used.

The polyvinylidene fluoride foam or polyvinyl fluoride foam forming the carrier layer 14 is dyed a desired colour and provided with a desired surface structure by embossing. The carrier layer 14 is joined to the surface layer 12 by welding.

Finally, an adhesive film 16 is applied to a surface of the carrier layer 12 which is facing away from the surface layer 12. The adhesive film 16 serves to join the interior fitting component 10 to a stiffening structure or a basic structure.

FIG. 2 shows a further embodiment of an interior fitting component 10, which, like the interior fitting component which is represented in FIG. 1, comprises a surface layer 12 formed by a printed transparent polyvinylidene fluoride film or polyvinyl fluoride film as well as a carrier layer 14 formed by a polyvinylidene fluoride foam or a polyvinyl fluoride foam of a desired density. The carrier layer 14 is again provided with a desired surface structure on its surface which faces the surface layer 12. An adhesive film 16 is again applied to a surface of the carrier layer 14 which is facing away from the surface layer 12.

However, in contrast to the interior fitting component which is represented in FIG. 1, the interior fitting component 10 which is shown in FIG. 2 comprises a carrier layer 14 which consists of an undyed polyvinylidene fluoride foam or polyvinyl fluoride foam. In order to give the interior fitting component 10 the desired colour, an intermediate layer 18 which consists of a dyed polyvinylidene fluoride film or polyvinyl fluoride film is present instead. The printed transparent polyvinylidene fluoride film or polyvinyl fluoride film forming the surface layer 12, the dyed polyvinylidene fluoride film or polyvinyl fluoride film forming the intermediate layer 18 and the polyvinylidene fluoride foam or polyvinyl fluoride foam forming the carrier layer 14 are joined together by welding.

The interior fitting component 10 which is shown in FIG. 3 corresponds in terms of its structure to the interior fitting component which is represented in FIG. 2. However the individual layers 12, 14, 18 of the interior fitting component 10 are joined together by gluing rather than welding in the embodiment which is represented in FIG. 3. For this reason the interior fitting component 10 is provided with adhesive layers 20, 22 between the surface layer 12 and the intermediate layer 18 as well as between the intermediate layer 18 and the carrier layer 14.

The interior fitting component 10 which is shown in FIG. 4 differs from the component which is shown in FIG. 2 in that it is provided with an intermediate layer 18′ consisting of a dyed lacquer instead of with an intermediate layer 18 formed by a dyed polyvinylidene fluoride film or polyvinyl fluoride film in order to give the interior fitting component 10 the desired colour. The lacquer which forms the intermediate layer 18′ may, for example, be a resin-based lacquer and applied to the printed transparent polyvinylidene fluoride film or polyvinyl fluoride film forming the surface layer 12 before this film is joined to the carrier layer 14. Otherwise the structure of the interior fitting component 10 which is shown in FIG. 4 corresponds to the structure of the component according to FIG. 2.

The different application possibilities of an interior fitting component 10 are illustrated in FIGS. 5A to C. As shown in FIG. 5A, an interior fitting component 10 which comprises a carrier layer 14 consisting of a dyed polyvinylidene fluoride foam or polyvinyl fluoride foam provided with a desired surface structure as well as a surface layer 12 consisting of a printed transparent polyvinylidene fluoride film or polyvinyl fluoride film and joined to the carrier layer 14 by an adhesive layer 24 can be applied to a panel-shaped basic structure 26. The interior fitting component 10 can be joined to the basic structure 26 via the adhesive film 16 which is shown in FIGS. 1 to 4. The interior fitting component 10 can be adapted particularly well to the shape of the basic structure 26 due to the flexibility of the carrier layer 14.

However, as an alternative to this, it is also possible to use the interior fitting component 10 as a self-supporting decorative shell, as shown in FIG. 5B. This is particularly applicable if the interior fitting component 10 is not subjected to high mechanical loads.

As shown in FIG. 5C, the interior fitting component 10 may in addition be joined to a stiffening structure 28 in order to improve its mechanical properties A composite component which is mechanically stable yet at the same time very lightweight is obtained as a result.

In order to produce an interior fitting component 10 according to the method which is shown in FIG. 6, a carrier layer 14 consisting of a polyvinylidene fluoride foam or polyvinyl fluoride foam is joined by a rolling step to a surface layer 12 formed by a transparent polyvinylidene fluoride film or polyvinyl fluoride film. For this purpose the layers 12, 14 are fed to a roll pair 30, with at least one roll of the roll pair 30 being constructed as a profiling roll. An adhesive layer 24 which is heated by means of a heating panel 32 to a desired elevated temperature is used to join the two layers 12, 14.

The carrier layer 14 is provided on its surface which faces the surface layer 12 with the surface structure represented in an enlarged form in FIG. 7 by rolling with the rolls 30 disposed opposite one another. Foamed regions 34 as well as compressed regions 36 are produced in the carrier layer 14 through the roll treatment. In particular in the compressed regions 36 of the carrier layer 14 the foam which forms the carrier layer 14 is welded to the plastics film which forms the surface layer 12 and therefore a particularly good bond between the carrier layer 14 and the surface layer 12 is obtained. Therefore in the rolling method which is represented in FIG. 6 only a single method step is required in order to provide the carrier layer 14 with the desired surface structure and to join it to the surface layer 12 at the same time.

1. Multi-layer aircraft interior fitting component (10) with a transparent surface layer (12) consisting of a thermoplastic plastics material,
characterised in that the aircraft interior fitting component (10) also comprises a carrier layer (14) consisting of a foam, which is joined to a stiffening structure (28), wherein the stiffening structure (28) extends over only a portion of a surface of the carrier layer (14) consisting of a foam which faces away from the transparent surface layer (12) consisting of a thermoplastic plastics material.

2. Multi-layer aircraft interior fitting component according to claim 1,
characterised in that the carrier layer (14) consisting of a foam is applied to a basic structure (26).

3. Multi-layer aircraft interior fitting component according to claim 1,
characterised in that the carrier layer (14) consisting of a foam is dyed.

4. Multi-layer aircraft interior fitting component according to claim 1,
characterised in that the carrier layer (14) consisting of a foam comprises an embossed surface structure on its surface which faces the transparent surface layer (12) consisting of a thermoplastic plastics material.

5. Multi-layer aircraft interior fitting component according to claim 1,
characterised in that the carrier layer (14) consisting of a foam consists of a thermoplastic foam, in particular polyvinylidene fluoride foam, polyvinvyl fluoride foam, polyamide foam, polysulphone foam or polyphenyl sulphone foam, or of silicone foam.

6. Multi-layer aircraft interior fitting component according to claim 1,
characterised in that the carrier layer (14) consisting of a foam is of a density between 15 kg/m³ and 120 kg/m³.

7. Multi-layer aircraft interior fitting component according to claim 1,
characterised by an intermediate layer (18) which consists of a dyed thermoplastic plastics material and is disposed between the carrier layer (14) consisting of a foam and the transparent surface layer (12) consisting of a thermoplastic plastics material.

8. Multi-layer aircraft interior fitting component according to claim 1,
characterised by an intermediate layer (18′) which consists of a dyed lacquer and is disposed between the carrier layer (14) consisting of a foam and the transparent surface layer (12) consisting of a thermoplastic plastics material.

9. Method for producing a multi-layer aircraft interior fitting component which comprises:
providing a transparent surface layer (12) consisting of a thermoplastic plastics material, characterised by joining a carrier layer (14) consisting of a foam to the transparent surface layer (12) consisting of a thermoplastic plastics material, and by joining the carrier layer (14) consisting of a foam to a stiffening structure (28) such that the stiffening structure (28) extends over only a portion of a surface of the carrier layer (14) consisting of a foam which faces away from the transparent surface layer (12) consisting of a thermoplastic plastics material.

10. Method according to claim 9,
characterised in that the carrier layer (14) consisting of a foam is dyed.

11. Method according to claim 9,
characterised in that a surface structure is embossed onto the carrier layer (14) consisting of a foam.

12. Method according to claim 9,
characterised in that an intermediate layer (18) consisting of a dyed thermoplastic plastics material is disposed between the carrier layer (14) consisting of a foam and the transparent surface layer (12) consisting of a thermoplastic plastics material.

13. Method according to claim 9,
characterised in that an intermediate layer (18′) consisting of a dyed lacquer is disposed between the carrier layer (14) consisting of a foam and the transparent surface layer (12) consisting of a thermoplastic plastics material.

14. Method according to claim 9,
characterised i that the carrier layer (14) consisting of a foam, the transparent surface layer (12) consisting of a thermoplastic plastics material, the intermediate layer (18) consisting of a dyed thermoplastic plastics material and/or the intermediate layer (18′) consisting of a dyed lacquer are joined together by hot-joining, welding or gluing.

15. Method according to claim 9,
characterised in that the carrier layer (14) consisting of a foam, the transparent surface layer (12) consisting of a thermoplastic plastics material, the intermediate layer (18) consisting of a dyed thermoplastic plastics material and/or the intermediate layer (18′) consisting of a dyed lacquer are roll-treated by at least one profiling roll (30) and joined together during rolling.

16. Method according to claim 9,
characterised in that the carrier layer (14) consisting of a foam is joined to a basic structure (26).
